(19) United States
(12) Patent Application Publication
(10) Pub. No.: US 2010/0175305 A1
(43) Pub. Date: Jul. 15, 2010

(54) Fishing Lure Having Variable Density Materials

(76) Inventors: Kurt E. Heikkila, Marine on St. Croix, MN (US); Rodney K. Williams, Stacy, MN (US); John S. Kroll, Blaine, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 12/646,088

(22) Filed: Dec. 23, 2009

Related U.S. Application Data
(60) Provisional application No. 61/140,680, filed on Dec. 24, 2008.

(51) Int. Cl. A01K 85/00

(52) U.S. Cl. 43/42.39; 43/42.53; 43/42.22; 43/43.14

(57) ABSTRACT

A fishing lure and method of making a fishing lure. The fishing lure having a body constructed of at least two different materials. One of the materials having a density that is at least two times greater than the other material. The method including depositing the two materials within a mold cavity such that the resulting fishing lure body has a particular center of gravity.

### CROSS-REFERENCE TO RELATED APPLICATION

This application claims the benefit of U.S. Provisional Patent Application Ser. No. 61/140,680, filed Dec. 24, 2008, which application is hereby incorporated by reference in its entirety.

### FIELD OF THE TECHNOLOGY

The present disclosure relates generally to devices for use in the outdoor sporting industry, and various methods associated with such devices. More particularly, this disclosure relates to fishing lures, and various methods associated with the use and manufacture of fishing lures.

### BACKGROUND

Manufacturers of fishing lures strive to design lures that create a sensory enticement to fish. Fish are often times attracted to movement, such as the movement of bait fish in water. Accordingly, some conventional lures have been design to move in the water similar to the way a bait fish would naturally move. To obtain such movement through the water, lures have been designed with differently weighted regions. The manufacturing process of constructing such weighted lures involves physically attaching a weight to the lure; for example, one conventional process includes drilling a hole in the lure, inserting a lead weight into the hole, and applying an adhesive to secure the lead weight within the lure hole. This process is time consuming and can often result in undesirable variances among the individual lures (such as weight variances or weight distribution/center of gravity variances). In general, conventional fishing lures and methods of manufacturing fishing lures can be improved.

### SUMMARY

One aspect of the present disclosure relates to a fishing lure having a lure body made of at least two portions of different materials. One of the materials has a density that is at least 1.5 times greater than the other material. In one embodiment, the desired density for each portion of the body can be attained by including materials that can reduce the density of one portion while materials that increase density can be added to the other portion The lure body is manufactured in a molding process that permits the manufacturer to selectively locate the lure's center of gravity to achieve a desired motion or orientation in water. The body of the invention can be made by thermal molding techniques or by mechanical assembly techniques.

A variety of examples of desirable product features or methods are set forth in part in the description that follows, and in part will be apparent from the description, or may be learned by practicing various aspects of the disclosure. The aspects of the disclosure may relate to individual features as well as combinations of features, including combinations of features disclosed in separate embodiments. It is to be understood that both the foregoing general description and the following detailed description are explanatory only, and are not restrictive of the claimed invention.

### BRIEF DESCRIPTION OF THE DRAWINGS

FIG. 1 is a perspective view of one embodiment of a fishing lure having a variable density composite material construction, in accordance with the principles disclosed;

FIG. 2 is a perspective view of a partial mold used in the manufacture of the fishing lure of FIG. 1; and

FIG. 3 is a perspective view of another embodiment of a fishing lure having a variable density composite material construction, in accordance with the principles disclosed.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

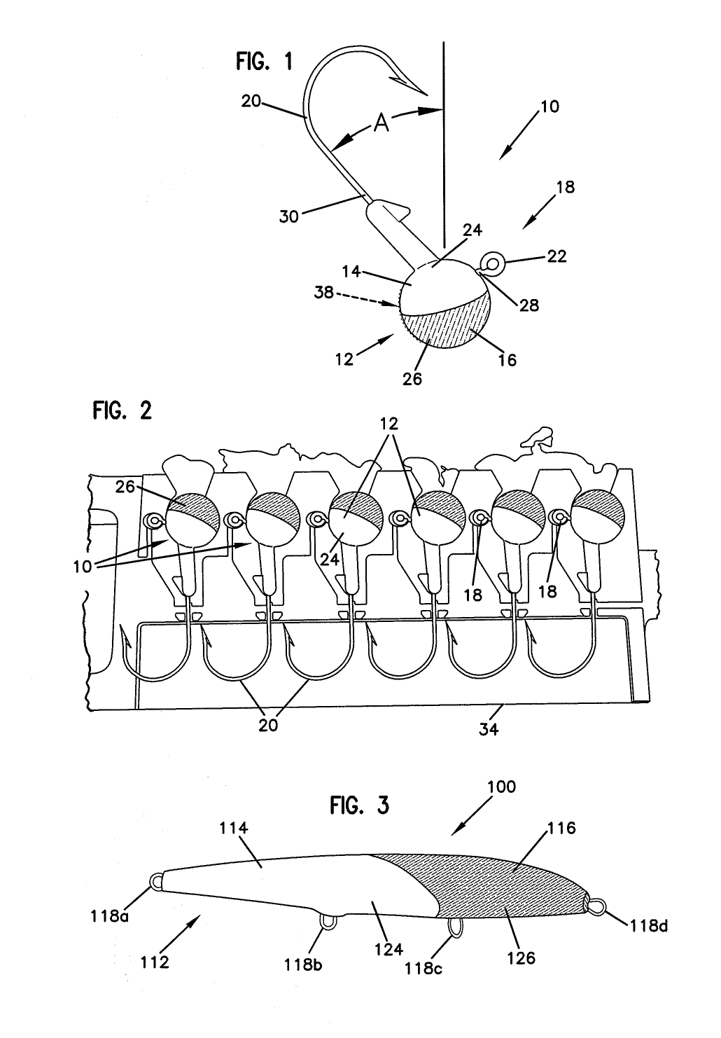

FIG. 1 illustrates one embodiment of a molded fishing lure 10 in accordance with the principles disclosed. The molded fishing lure 10 is designed to have a particular movement and/or orientation in water due to a predetermined, selected center of gravity. The fishing lure's predetermined, selected center of gravity is constructed during a molding process. Conventional methods of attaching a weight to an existing lure construction, and the costs and variance problems associated with such methods are eliminated. The disclosed method of making a lure instead permits the production of a low-cost lure having a more precise center of gravity that effects a particular movement or orientation in water. As will be described in further detail, the presently disclosed method further permits a manufacturer to “predetermine” and/or “select” the placement of a lure's center of gravity so that fishing lure embodiments having different particular movements and orientations in water can be produced. In addition, the present method provides for the production of lures having shapes not achievable in conventional cast-lead lure manufacture or in wooden lure manufacture. The ability to combine unique shapes with selected placement of a lure's center of gravity offers lure designers greater flexibility and freedom in creating a desired lure movement in water.

Referring still to FIG. 1, the illustrated fishing lure 10 generally includes a lure body 12. The lure body 12 includes formed first and second body portions 14, 16. The “lure body” 12 is a body in which various inserts and hardware, such brushes, wires, hooks, or eyelets, may be embedded, or to which various inserts and hardware may be secured. The body portions 14, 16 that form the lure body 12 therefore excludes inserts and hardware embedded within or secured to the lure body 12 (e.g., excludes brushes, wires, hooks, eyelets, functional attachment components, decorative components or other alternative attachment elements used to attach bait, line, or hooks). In our latest designs, we are actually obtaining integrally formed lure body via a mechanical interlock by forming the body portions with mating interlock features and then fitting the portions together in the final body. The latest polymers do not thermally fuse. Our earlier products do thermally fuse. Both provide a viable means to making an integrally formed lure body.

The solid lure body 12 is constructed of a first selected material 24 that defines the first body portion 14 and a second selected material 26 that defines the second body portion 16. The second material 26 is different than the first material 24. In the illustrated embodiment, the lure body 12 includes only the first and second body portions 14, 16, and is accordingly made of only the first and second materials 24, 26.

In alternative embodiments, the solid lure body 12 may include more than two formed body portions, each body portion being defined by materials different than the other body portions. A third body portion, for example, can be used to provide a center of mass that creates movement in the water in a direction different than the direction of movement created by the other body portions.

Referring back to the embodiment of FIG. 1, while the first and second materials 24, 26 integrally form the lure body 12, each material forms a particular region of the body, as opposed to being blended, combined, or located together in a common area. These particular regions are interconnected together at a fusing region or interface where the two materials may fuse together or via injecting one material around another a mechanical interlock may be created between the two materials. At the fusing region or interface, some of the material from either one or both body portions is combined with the material of the other body portion to form the interconnection between the particular regions or body portions. As can be understood, the volume of the fusing region where the two materials fuse together is considerably small in comparison to the volume of the particular regions that each material forms.

The first material 24 of the first body portion 14 can have reduced density using a number of density reducing techniques. The first material can be made of foamed materials. A formed body can be machined to remove material to a final desired density. One useful technique is to include reduced density materials in the body. Such reduced density materials can include, for example, hollow glass spheres. Hollow glass spheres are widely used in industry as additives to polymeric compounds, e.g., as modifiers, enhancers, rigidifiers and fillers. These spheres are strong enough to avoid being crushed or broken during further processing of the polymeric compound, such as by high pressure spraying, kneading, extrusion or injection molding. Proper distribution of the glass spheres is completed by maintaining appropriate viscosity of the polymer/glass sphere formulation. Furthermore, it is desirable that these spheres be resistant to leaching or other chemical interaction with their associated polymeric compound. The method of expanding solid glass particles into hollow glass spheres by heating is well known. See, e.g., U.S. Pat. No. 3,365,315. Glass is ground to particulate form and then heated to cause the particles to become plastic and for gaseous material within the glass to act as a blowing agent to cause the particles to expand. During heating and expansion, the particles are maintained in a suspended state either by directing gas currents under them or allowing them to fall freely through a heating zone. Sulfur, or compounds of oxygen and sulfur, serves as the principal blowing agent. A number of factors affect the density, size, strength, chemical durability and yield (the percentage by weight or volume of heated particles that become hollow) of hollow glass spheres. These factors include the chemical composition of the glass; the sizes of the particles fed into the furnace; the temperature and duration of heating the particles; and the chemical atmosphere (e.g., oxidizing or reducing) to which the particles are exposed during heating.

There have been problems in attempting to improve the quality and yield of hollow glass spheres. One reason is that it was believed that the percentage of silica (SiO₂) in glass used to form hollow glass spheres should be between 65 and 85 percent by weight and that a weight percentage of SiO.sub.2 below 60 to 65 percent would drastically reduce the yield of the hollow spheres.

In use in the manufacture of the present fishing lure 10, the hollow glass spheres have average densities of about 0.1 grams-cm⁻³ to approximately 0.6 grams-cm⁻³ or about 0.12 grams-cm⁻³ to approximately 0.4 grams-cm⁻³ and are prepared by heating solid glass particles. For a product of hollow glass spheres having a particular desired average density, there is an optimum sphere range of sizes of particles making up that product which produces the maximum average strength. One such sphere range of size is between 10 μm and 125 μm.

Hollow glass spheres used commercially can include both solid and hollow glass spheres. All the particles heated in the furnace do not expand, and most hollow glass-sphere products are sold without separating the hollow from the solid spheres.

The second material 26 of the second body portion 16 can include materials that can increase density for example, lead, tin, bismuth, stainless steel, and tungsten. Other materials and manufacturing techniques associated with molding such materials that can be used and employed to manufacture the different body portions of the disclosed fishing lure 10 are described in U.S. Patent Application Nos. 60/022,016 and 10/988,214; which applications are incorporated herein by reference. Foaming agents can further be incorporated into the selected materials to obtain body portions having a particular specific gravity or density. Additionally, a relatively large void space may be created at the interface to create unique swimming action.

In one embodiment, the second material 26 of the fishing lure 10 has a specific gravity or density that is at least 1.5 times greater than that of the first material 24. In another embodiment, the second material 26 of the fishing lure 10 has a specific gravity or density that is at least 2 times greater than that of the first material 24. In the illustrated embodiment of FIG. 1, the solid lure body 12 has a generally spherical shape. The second body portion 16 having the greater specific gravity defines a leading lure portion of the spherical lure body 12; the first body portion 14 defines a trailing lure portion. The leading lure portion (i.e., 16) has a sink rate greater than that of the trailing lure portion (i.e., 14) to produce a particular motion and orientation in water.

The spherical lure body 12 of FIG. 1 has an overall specific gravity of between about 0.3 and 12.0 grams per cubic centimeter. The second body portion 16 has a specific gravity of at least about 5.0 grams per cubic centimeter, while the first body portion 14 has a specific gravity of less than about 3.3 grams per cubic centimeter, 2.0 grams per cubic centimeter; e.g., a specific gravity of about 0.2 to 1.0 grams per cubic centimeter. In one embodiment, the specific gravity of the second material 26 of the second body portion 16 is about 7.6 grams per cubic centimeter, and the specific gravity of the first material 24 of the first body portion 14 is about 0.8 grams per cubic centimeter. In another embodiment, the specific gravity of the first material 24 is about 0.4 grams per cubic centimeter to emulate the buoyant properties of wood.

The present fishing lure 10 accordingly has a variable density lure body 12 (e.g., a dual density lure body). Conventional lead jigs, for example, do not have variable densities within the jig's given shape or body. Likewise, plastic crank baits, metal spoons, and artificial wood minnows do not have solid bodies with variable densities.

Still referring to FIG. 1, the fishing lure 10 can include a number of different inserts or hardware. For example, the present fishing lure 10 includes an attachment 18 having an eyelet 22 and a stem 28. As will be described in greater detail hereinafter, the attachment 18 can be secured to the lure body 12 by molding at least one of the first and second body portions 14, 16 of the lure body around the attachment stem 28. In the alternative, the attachment stem 28 can be threaded into one of the first and second body portions 14, 16 of the lure body 12. A hook 20 can also be secured to the lure body 12. In the illustrated embodiment, the hook 20 is secured by molding at least one of the first and second body portions 14, 16 of the lure body 12 around a shank 30 of the hook 20. By molding each material around a hook insert, the strength and integrity of the integrally formed fishing lure can be increased.

In general, the fishing lure 10 has a weight and a volume. A majority of the weight of the fishing lure 10 is defined by the combined weight of the first and second body portions 14, 16 of the lure body 12. Further, in the illustrated embodiment, a majority of the weight of the fishing lure 10 is defined by the weight of the second body portion 16 of the lure body 12. A majority of the volume of the fishing lure 10 is defined by the first and second body portions 14, 16 of the lure body 12.

The present fishing lure 10 also has a density. The density of the fishing lure 10 remains constant during use of the lure 10. That is, the fishing lure does not have a body that fills with water or absorbs water so as to change the density of the fishing lure, and does not otherwise have an adjustable density. The density is instead selected and predetermined at the time of manufacturing in correspondence with the selected first and second materials 24, 26 of the lure body 12, as described above.

With that, the present disclosure further relates to a method of manufacturing a fishing lure. The method includes placing materials having desired specific gravities in strategic locations within a fishing lure mold to obtain unique lure motion (including sink rate, movement, and orientation in water when fishing). In one method, melt molding technology is used to create a composite lure body with segments or regions of lower and higher density materials, as previously described. The lower and higher density materials have different buoyant forces and are utilized to obtain a wide range of lure motions depending on the density distribution within the lure body. For example, the lure can be weighted heavily to the front with high buoyancy in the rear, weighted heavily to the back with high buoyancy in the front, or weighted heavily to the bottom with high buoyancy at the top, and etc.

Referring now to FIG. 2, one part of a mold 34 used in the manufacture of the fishing lure 10 of FIG. 1 is illustrated. The mold 34 has a plurality of mold cavities (shown filled). The mold cavities define the shape of the lure body 12.

In one method of manufacture, a predetermined amount of one of the first and second materials 24, 26 is deposited (e.g., injected or introduced) into the mold cavity. The deposited material is permitted to harden, the mold 34 opened, and the hardened deposits removed. An unwanted portion of the hardened deposit is then removed (e.g., cut away or trimmed) and the modified hardened deposits returned to mold cavities. The other of the first and second materials 24, 26 is then deposited into the mold cavity wherein the two materials fuse to one another to form the lure body 12.

In another method of manufacture, a divider is positioned within the mold cavity to divide the mold cavity into two regions. A predetermined amount of one of the first and second materials 24, 26 is deposited into one of the two regions. The deposited material is permitted to harden, the mold 34 opened, and the divider removed. The other of the first and second materials 24, 26 is then deposited into the mold cavity wherein the two materials fuse together to form the lure body 12. In a similar fashion, two molds can be utilized; the first mold provides an appropriate fill area for only the first material. The molded first material is then removed from the first mold and placed into the second mold. The second material is then injected into the second mold to complete the overall shape of the lure. Mechanical interlocks can be designed using this method whereby the second material upon cooling becomes hard and inseparable from the other(s).

In still another method of manufacture, a predetermined amount of one of the first and second materials 24, 26 is deposited into the mold cavity. The deposited material may be permitted to slightly harden. A predetermined amount of the other one of the first and second materials 24, 26 is deposited into the mold cavity. The first and second materials fuse together to form the lure body 12.

Further details of manufacturing techniques that can be used in accordance with the present disclosure are described in U.S. Patent Application No. 60/022,016; which application is previously incorporated herein by reference.

As shown in FIG. 2, selected inserts, such as hooks 20 and attachments 18, may be placed relative to the mold cavities so that one or both of the first and second body portions 14, 16 of the lure bodies 12 form around the inserts. In this particular arrangement, the hook 20 is placed to extend from the lure body 12 such that during use of the fishing lure 10, the hook extends generally upward from the lure body at an angle A as shown in FIG. 1. FIG. 1 illustrates the particular angle A at which the hook 20 extends when the lure 10 is suspended in water. The particular angle A is dependent upon the center of gravity of the lure 10, and accordingly the selected placement and amount of the second material 26 relative to the first material 24. In the illustrated embodiment the particular angle A is between about 30 and 60 degrees; more specifically, about 45 degrees relative to a vertical plane.

After the formation of the lure body 12 (with or without inserts), the lure body 12 may undergo further processing whereby an outer layer 38 is applied to the lure body 12 (the outer layer 38 shown partially and schematically in FIG. 1). The outer layer 38 may cover/coat only a portion of the lure body 12 or may cover/coat the entire lure body 12. The outer layer may include, for example, a protective coating that protects the lure body from environmental elements and/or wear, or may include a paint layer having a color that attracts fish.

One aspect of the present method of manufacturing the fishing lure 10 is the ability to more precisely and more accurately manufacture a number of fishing lures each of which effects the same desired motion and orientation in the water. For example, during the deposit of the denser second material 26, the material is placed at a predetermined location within the cavity such that the resulting lure body 12 has a center of mass that creates the desired motion and orientation in the water. The amounts and locations of the materials 24, 26 of the resulting lure body 12 can be selected and controlled, the present molding process thereby eliminating variances associated with conventional lure assembly processes.

In another aspect, the presently disclosed method permits the manufacturer to create a wide range of lure designs. That is, the present variable density molding method allows manufacturers to adapt designs by selecting the strategic locations at which to create a center of gravity, and by allowing manufacturers to utilize a wide variety of materials with different densities. This, in combination with the ability of create unique shapes by way of molding, offers manufacturers greater flexibility and freedom in the creation of lure designs.

In general, the present method of fusing high and low density materials in one mold provides a cost effective and efficient way of obtaining variable density lure bodies, and further allows manufacturers to strategically select and place centers of gravity in a given lure body shape, with greater accuracy. As can be understood, the present method also increases production rates for manufacturers of lures with the above described features. In addition, polymeric thermoplastic materials have physical properties that are different than conventional lure materials, such as lead, especially in flexural modules or stiffness. The utilization of polymeric thermoplastic materials, for example, in the manufacture of a lure allows for the provision of shapes (fins and other projections) that aren't possible with such conventional materials.

Referring now to FIG. 3, another embodiment of a molded fishing lure 100 is illustrated. The molded fishing lure 100 is designed to have a particular movement in water due to a predetermined, selected center of gravity. In particular, the fishing lure 100 generally includes a solid lure body 112 constructed of a first selected material 124 that defines a first body portion 114 and a second selected material 126 that defines a second body portion 116. The second material 126 is different than the first material 124. In the illustrated embodiment, the lure body 112 includes only the first and second body portions 114, 116, and is accordingly made of only the first and second materials 124, 126.

The first and second material 124, 126 of the fishing lure 100 can include the same materials with the densities and density differentials as previously described. In this particular embodiment, the solid lure body 1a2 has an elongated bait-fish shape. What is meant by “bait-fish” shape is that the lure body 112 is shaped like a small fish used as bait to attract predatory fish, particularly game fish. Examples of marine bait fish include anchovies, halfbeaks, and scad. Freshwater bait fish include any fish of the minnow or carp family (Cyprinidae), sucker family (Catostomidae), top minnows or killifish family (Cyprinodontidae), shad family (Clupeidae), sculpin family (Osteichthyes), or sunfish family (Centrarchidae). Other bait-fish shaped bodies resembling different species of bait fish can be used.

In the illustrated embodiment, the second body portion 116 having the greater specific gravity defines a leading lure portion of the bait-fish lure body 112; the first body portion 114 defines a trailing lure portion. The leading lure portion (i.e., 116) has a sink rate greater than that of the trailing lure portion (i.e., 114) to produce a particular motion and orientation in water. In particular, the fishing lure 100 has a forward diving motion and orientation in water.

Still referring to FIG. 3, the fishing lure 100 includes a number of inserts or attachments 118a-d. The attachments 118a-d each include an eyelet 122 and a stem 128. As previously described, the attachments 118 can be secured to the lure body 112 by molding at least one of the first and second body portions 114, 116 of the lure body around the attachment stem 128. In the alternative, the attachment stem 128 can be threaded into one of the first and second body portions 114, 116 of the lure body 112. In the illustrated embodiment, the rear and bottom attachments 118a-c can be used for securing treble-hooks, for example; the front attachment 118d can be used for attaching line and/or a leader.

Similar to the previous embodiment, the fishing lure 100 has a weight and a volume. A majority of the weight of the fishing lure 100 is defined by the combined weight of the first and second body portions 114, 116 of the lure body 112. In addition, a majority of the volume of the fishing lure 100 is defined by the first and second body portions 114, 116 of the lure body 112.

The present fishing lure 100 also has a density. The density of the fishing lure 100 remains constant during use of the lure 100. That is, the fishing lure does not have a body that fills with water or absorbs water so as to change the density of the fishing lure, and does not otherwise have an adjustable density. The density is instead selected and predetermined at the time of manufacturing in correspondence with the selected first and second materials 124, 126 of the lure body 112, as described above.

With that, the present fishing lure 100 can be manufactured by the molding processes previously described wherein predetermined amounts of the first and second materials 124, 126 are deposited into a mold cavity. The predetermined amounts are strategically located within the mold cavity such that the lure's center of gravity effects the desired motion in water.

The present lure bodies described herein are directed toward solid lure bodies. It is contemplated that hollow body that may include, for example, an internal rattle, can be manufactured in accordance with the principles disclosed.

The above specification provides a complete description of the present invention. Since many embodiments of the invention can be made without departing from the spirit and scope of the invention, certain aspects of the invention reside in the claims hereinafter appended.

What is claimed is:

1. A fishing lure, comprising:
a) a lure body including integrally formed first and second body portions, the first body portion being made of a first material, the second body portion being made of a second material different than the first material, the second material having a specific gravity at least 1.5 times greater than that of the first material; and
b) wherein the fishing lure has a density that remains constant during use.

2. The fishing lure of claim 1, wherein the lure body is made of only the first and second materials.

3. The fishing lure of claim 2, further including an outer layer that covers at least a portion of the lure body.

4. The fishing lure of claim 3, wherein the outer layer is a paint layer.

5. The fishing lure of claim 1, wherein the fishing lure defines a volume, a majority of the volume being defined by the first and second body portions.

6. The fishing lure of claim 1, wherein the lure body has a generally elongated shape, a front end of the elongated lure body being defined by the second body portion, a rear end of the elongated lure body being defined by the first body portion.

7. The fishing lure of claim 1, wherein the lure body has a generally spherical shape first body portion has a specific gravity of less than about 3.3 grams per cubic centimeter and The second body portion has a specific gravity of greater than about 5.0 grams per cubic centimeter.

8. The fishing lure of claim 1, wherein the second body portion defines a leading lure portion and the first body portion defines a trailing lure portion, the leading lure portion having a sink rate greater than that of the trailing lure portion.

9. The fishing lure of claim 1, wherein the lure body has a specific gravity of between about 0.3 and 12.0 grams per cubic centimeter.

10. The fishing lure of claim 9, wherein the second body portion has a specific gravity of at least about 5.0 grams per cubic centimeter.

11. The fishing lure of claim 9, wherein the first body portion has added material that reduces density of the body material and the second body portion has added material that increases density of the body material.

12. The fishing lure of claim 1, wherein the specific gravity of the second material is at least 2 times greater than that of the first material.

13. The fishing lure of claim 1, wherein the specific gravity of the second material is at least 3 times greater than that of the first material.

14. The fishing lure of claim 1, wherein the second material has a specific gravity of at least about 5.0 grams per cubic centimeter and the first material has a specific gravity of less than about 2.0 grams per cubic centimeter.

15. The fishing lure of claim 14, wherein the specific gravity of the second material is about 7.6 grams per cubic centimeter and the specific gravity of the first material is about 0.8 grams per cubic centimeter.

16. The fishing lure of claim 1, further including an attachment comprising an eyelet having an attachment stem, the attachment stem being secured to the lure body.

17. The fishing lure of claim 16, wherein one of the first and second body portions of the lure body is molded around the attachment stem.

18. The fishing lure of claim 16, wherein the attachment stem is threaded into one of the first and second body portions of the lure body.

19. The fishing lure of claim 1, wherein the lure body has a solid construction.

20. A fishing lure, comprising:
a) a generally spherical body, including:
i) a first portion made of a first material; and
ii) a second portion integrally formed with the first portion, the second portion being made of a second material different than the first material, the second material having a specific gravity at least 2 times greater than that of the first material, the second material effecting a selected, predetermined center of gravity of the fishing lure; and
b) a hook and an eyelet molded into the spherical body, the hook extending from the spherical body relative to the second portion such that during use of the fishing lure, the hook extends generally upward from the spherical body at a predetermined angle.

21. A fishing lure, comprising:
a) a generally elongated bait fish body, the elongated body including a forward body portion integrally formed with a rearward body portion, the rearward body portion being made of a first material, the forward body portion being made of a second material different than the first material, the second material having a specific gravity at least 2 times greater than that of the first material; and
b) an eyelet secure to a front end of the forward body portion of the elongated bait fish body;
c) wherein the second material of the forward body portion causes the elongated bait fish body to dive during use.

22. A method of making a fishing lure, the method comprising the steps of:
a) providing a mold having a mold cavity defining a shape of a lure body;
b) depositing a first of only two materials into the mold cavity;
c) depositing a second of the two materials into the mold cavity, the second material having a density at least 2 times greater than that of the first material; and
d) integrally forming the two materials via mechanical interlock or fusing the two materials together to form a lure body having a first body portion made of the first material and a second body portion made of the second material;
e) wherein the step of depositing the second material includes placing the second material at a pre-determined location within the mold cavity such that the resulting lure body has a center of mass that effects a particular desired motion in water.
